(19) United States
(12) Patent Application Publication
(10) Pub. No.: US 2010/0327551 A1
(43) Pub. Date: Dec. 30, 2010

(54) Bicycle

(76) Inventors: Wan-Chi Liu, Hsinchu City (TW); Shih-Wen Liu, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/458,040

(22) Filed: Jun. 30, 2009

(51) Int. Cl. B62M 1/08

(52) U.S. Cl. 280/251

(57) ABSTRACT

This invention relates to a bicycle structure which essentially provides a bicycle body enabling stand-riding such that the weight center of human body can be more concentrated between the front wheel and the rear wheel, and that the wheel base between the front wheel and the rear wheel can be shortened. Thus, the volume of the bicycle is further reduced to become more compact and to save cost. Transmission units are provided respectively at both sides of the bottom, which are independently operated and include pedals moving up and down. Freewheels are provided respectively at both sides of the rear wheel of the bicycle body, and the transmission units at both sides are respectively connected to the freewheels. Not only the structure is simple for easy assembly, but also the volume after folding is very small for easy carry. A number of speed change points can also be provided on each transmission unit to increase the stroke of the freewheel so that the goal of speed change can be achieved. Accordingly, the bicycle structure has utmost convenience in practical implementation.

### BACKGROUND OF THE INVENTION

1. Field of the Invention

This invention relates to a bicycle structure, especially to a bicycle enabling stand-riding, having small volume, being more compact and cost-saving, with simple structure for easy assembly and for easy carry.

2. Brief Description of Prior Art

Due to global warming and climate change, worldwide oil price upsurging and rising of recreation and exercise practice, more and more people choose bicycle, having environment protection, healthful and commuting functions, as the means for short-range transportation or exercise. Not only match fashion, save money but also achieve energy-saving and carbon reduction, bicycle is a trigger for business chance with EV concept. Even each big market also rushes to promote all kinds of bicycle. Accompanying with the growing awareness of customer on EV and carbon reduction and furthermore with the factor of two-day weekend, bicycle is no longer just the means of transportation for shopping, visiting friend and trafficking, a lot of people use bicycle as the means for fitness and exercise due to the advantages of no oil consumption, noiseless, no pollution, and convenience in usage; even use bicycle as a recreation and excursion companion for traveling around the island.

The above bicycle is pivotally connected with a front wheel and a rear wheel at the front and the read sides of the bottom. The top end of the front wheel is provided with a stem for controlling the forward direction of the bicycle, and a saddle is vertically provided at the middle segment of the bicycle.

However, the abovementioned bicycle has the following shortcomings in practical usage.

1. The abovementioned bicycle is mostly bulk in volume. This not only causes inconvenience in delivery and storage but also triggers besetting due to bigger space wanted in parking the bicycle.

2. If the abovementioned bicycle is a folding type, telescopic structure and folding structure should be provided on each part of the frame and this will cause cost-up and difficulty in assembly accordingly. The bicycle after folding still has considerable weight which is unfavorable to carry.

### SUMMARY OF THE INVENTION

In view of the above facts, inventor of the present invention provides a bicycle enabling stand-riding such that the weight center of human body can be further concentrated between the front wheel and the rear wheel. Accordingly, the wheel base between the front wheel and the rear wheel can be shortened; the volume of the bicycle is further reduced to become more compact and more light-weighted so as to achieve cost-saving effect. Not only the structure is simple for easy assembly, but also the volume after folding is very small for easy carry.

The preferred embodiment of the bicycle of this invention is characterized in that the bicycle essentially has a bicycle body with a design of no saddle, the bicycle body having the advantages of short wheel-base between the front and the rear wheels, light-weight, small volume and cost-saving; transmission units being provided respectively at both sides of the bottom, which include pedals moving up and down respectively; freewheels being provided respectively at both sides of the rear wheel of the bicycle body, and the transmission units at both sides being independently operated such that the rider can stand on the pedal to enjoy free-motion comfortably.

According to the first preferred embodiment of the bicycle of the present invention, each pedal is connected to one end of a crank the side edge of which is pivotally connected to the side of the bottom center of the bicycle, an elastic member being provided on each crank for providing the elastic force required for pedal's restoration, the other end of each crank being pivotally connected to the respective freewheel of the bicycle body.

According to another preferred embodiment of the bicycle of the present invention, each pedal is provided with a vertical rail for facilitating the up-and-down movement of the pedal so as to drive the bicycle moving forward.

### BRIEF DESCRIPTION OF THE DRAWINGS

FIG. 1 is a schematic perspective view showing the first embodiment of the present invention.

FIG. 2 is an enlarged side view showing the first embodiment of the present invention.

FIG. 3 is an enlarged side view showing the second embodiment of the present invention.

FIG. 4 is a view showing the first state of speed change of the second embodiment of the present invention.

FIG. 5 is a view showing the second state of speed change of the second embodiment of the present invention.

FIG. 6 is an enlarged side view showing the third embodiment of the present invention.

FIG. 7 is an enlarged side view showing the fourth embodiment of the present invention.

FIG. 8 is an enlarged side view showing the fifth embodiment of the present invention.

FIG. 9 is an enlarged side view showing the sixth embodiment of the present invention.

### DETAILED DESCRIPTION OF PREFERRED EMBODIMENTS

The technical content, objects and effectiveness of the present invention will become more apparent by the detailed description of preferred embodiments of the present invention in conjunction with the accompanying drawings.

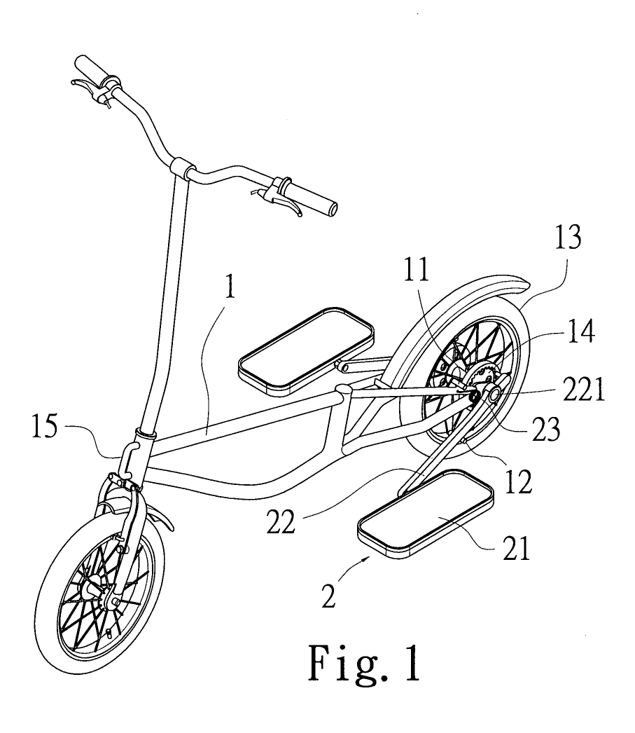

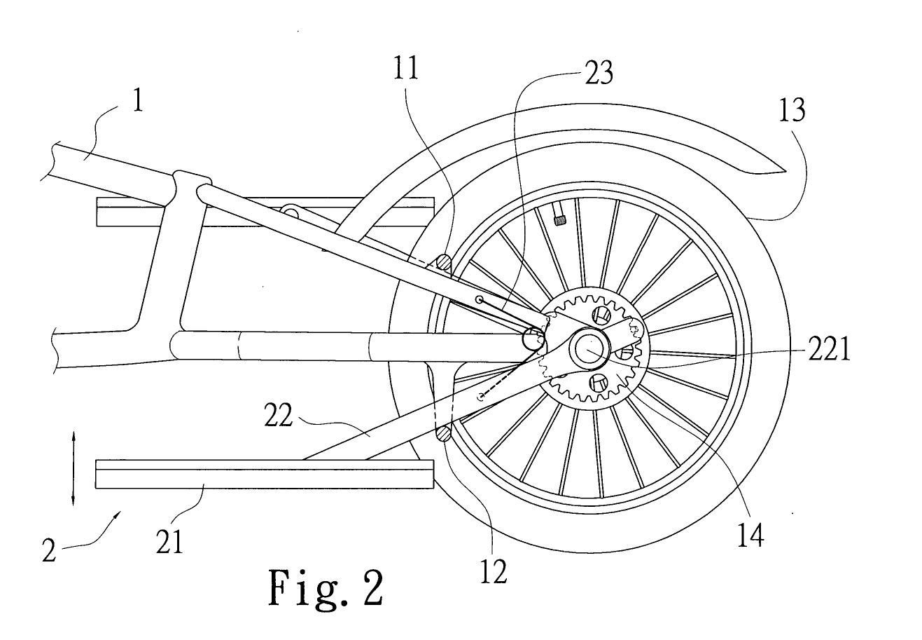

Firstly referring to FIGS. 1 and 2 showing schematic views of the first embodiment of the bicycle of the present invention, which comprises a bicycle body (1) and a number of transmission units (2).

The bicycle body (1) is a design without saddle, with short wheel base between the front and the rear wheels, with light weight, with small volume and cost-saving effect. On both sides of the bicycle body (1), an upper limiter (11) and a lower limiter (12) are provided respectively at the upper and lower ends corresponding to the cranks (22) of the transmission units (2) for limiting the movement range of the cranks (22). Moreover, freewheels (14) are respectively provided at both sides of the rear wheel (13) pivotally connected at the rear side of the bicycle body (1), which are connected to the transmission units (2). A handle (15) is fixed at the front end of the bicycle body (1) for hand carry usage.

The transmission units (2) comprises pedals (21) moving up and down. For example, each pedal (21) is connected to one end of the crank (22) the side edge of which is pivotally connected to the bicycle body (1) to serve as a rotary shaft (221), and the other end of the crank (22) is connected to the freewheel (14) of the bicycle body (1) which moves the rear wheel (13) to rotate. An elastic member (23) is provided at a place corresponding to the rotary shaft (221), which provides elastic force required for the restoration of the pedal (21).

Referring to FIGS. 1 and 2, when conducting the assembly, the side edge of the crank (22) of each transmission unit (2) is pivotally connected to the side at the bottom rear end the of the bicycle body (1) to serve as rotary shaft (221), and the other end of each crank (22) is pivotally connected in bias to the freewheel (14) respectively at the both sides of the bicycle body (1). In this manner, both pedals (21) of transmission units (2) together drive the rear wheel (13) to rotate so as to move the bicycle body (1) forward.

Referring to FIGS. 1 and 2, when in usage, user firstly stamps on the pedal (21) of each transmission unit (2), then one pedal (21) is stamped down so that the freewheel (14) is moved by the other end of the crank (22) to rotate in the counterclockwise direction until the crank (22) abuts the lower limiter (12), simultaneously the rear wheel (13) is rotated in counterclockwise direction so as to move the bicycle body (1) forward. When the force applied on the pedal (21) is stopped, the elastic member (23) pull the crank (22) upward so that the pedal (21) is restored to its original position until the crank (22) abuts against the upper limiter (11). In this manner, the process of stamping on each pedal (21) is repeatedly conducted to rotate the rear wheel (13) continuously so that the bicycle body (1) can keep on moving. Inasmuch as each transmission is individually operated, application of the whole weight of the rider on his two feet through the pedals (21) at both sides will move the cranks (22) downward until the cranks (22) abut against the lower limiters (12). At this moment, the two pedals (21) are present at the same height level so that the rider can stand on the pedals (21) comfortably and allow the bicycle body (1) to conduct free motion. When arrives destination, the bicycle can be folded to utmost small volume for easy carry due to the no-saddle design of the bicycle body (1). In this case, the handle (15) provided at the front end of the bicycle body (1) can be gripped by users for easy carrying.

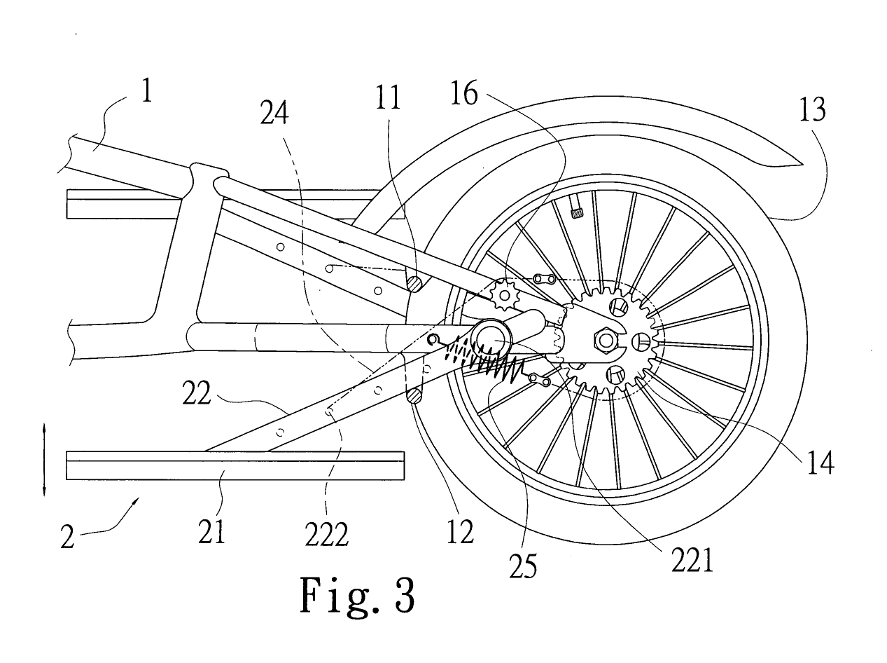

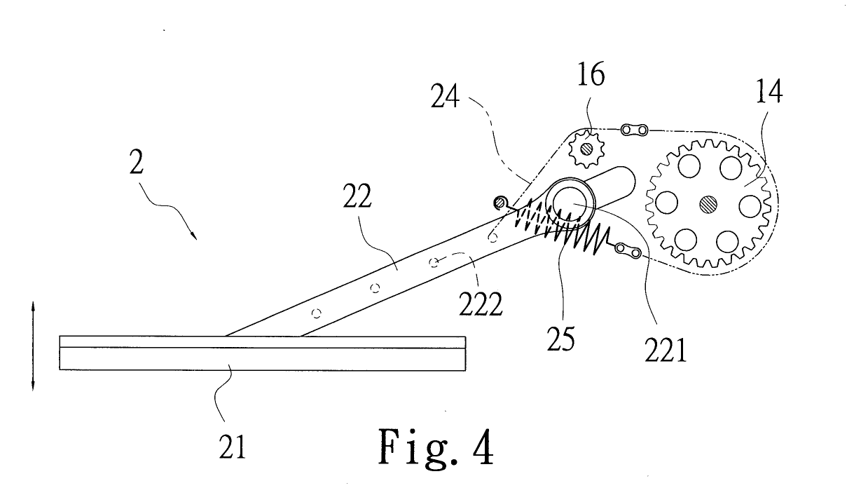

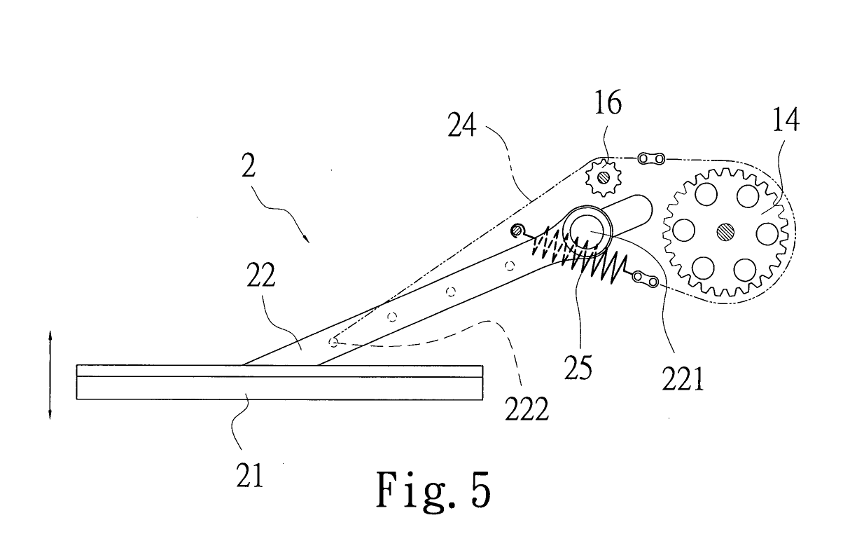

Referring to FIG. 3 showing a schematic view of the second embodiment of the bicycle of the present invention, the difference of this embodiment with the first embodiment is described as below. One end of a transmission member (24) such as a chain is connected to the crank (22) of each transmission unit (2), while the other end the transmission member (24) is connected to one end of an elastic member (25) and the other end of the elastic member (25) is fixed on the side face of the bicycle body (1). A fixed pulley (16) is pivotally connected near the top end at the rear side of the bicycle body (1), and the transmission member (24) is engaged on the outer peripheral edges of the freewheel (14) of the bicycle body (1) and the fixed pulley (16) so that the stroke of the transmission member (24) is increased by the fixed pulley (16). In this manner, when one pedal (21) is stamped down, the crank (22) of this pedal (21) will pull the transmission member (24) to cause counterclockwise rotation until the crank (22) abuts against the lower limiter (12). In turn, the transmission member (24) causes the counterclockwise rotation of the freewheel (14) and the rear wheel (13) so as to move the bicycle body (1) forward. When the force applied on this pedal (21) is stopped, the elastic member (25) will pulls the transmission member (24) and restores the pedal (21) back to its original position until the crank (22) abuts against the upper limiter (11). In this manner, the process of stamping on each pedal (21) is repeated to rotate the rear wheel (13) continuously so that the bicycle body (1) can keep on moving. Further referring to FIGS. 4 and 5, a number of speed change points (222) are provided along each crank (22) for fixedly connecting with the transmission member (24). If the transmission member (24) is fixed on the speed change point (222) remote from the rotary shaft (221), the stroke of the transmission member (24) and the freewheel (14) can also be increased to achieve the goal of speed change.

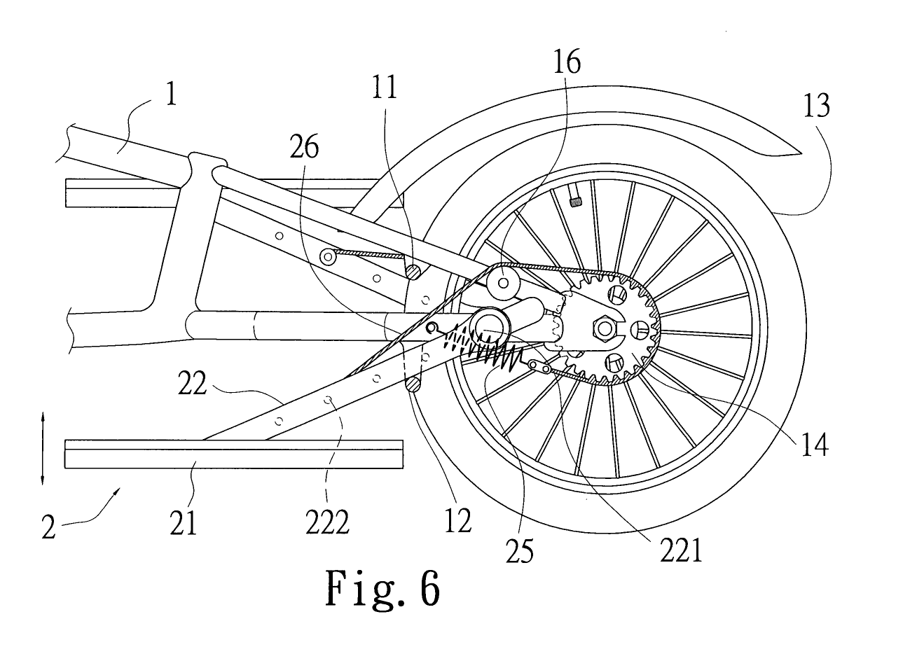

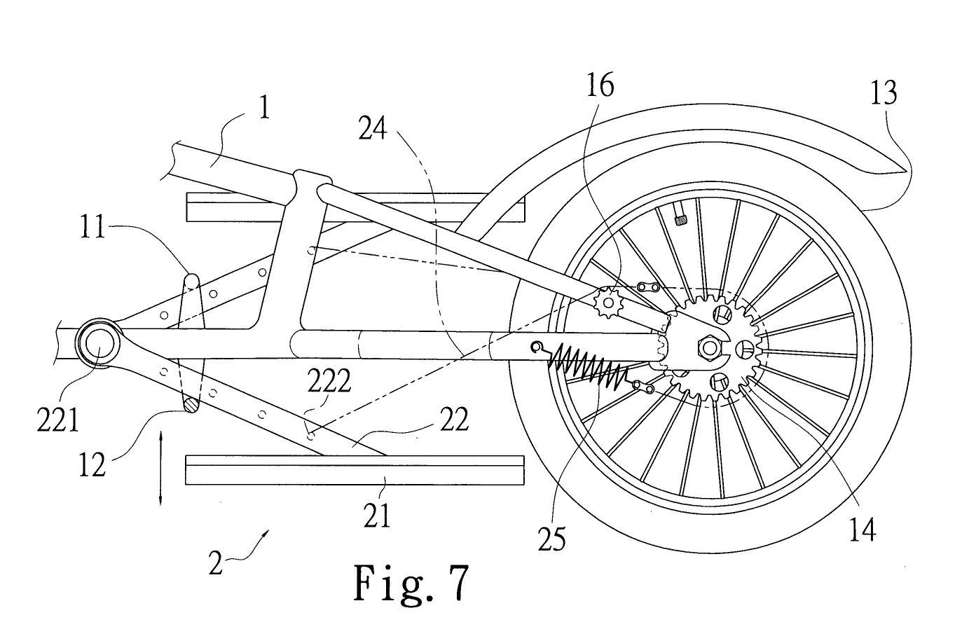

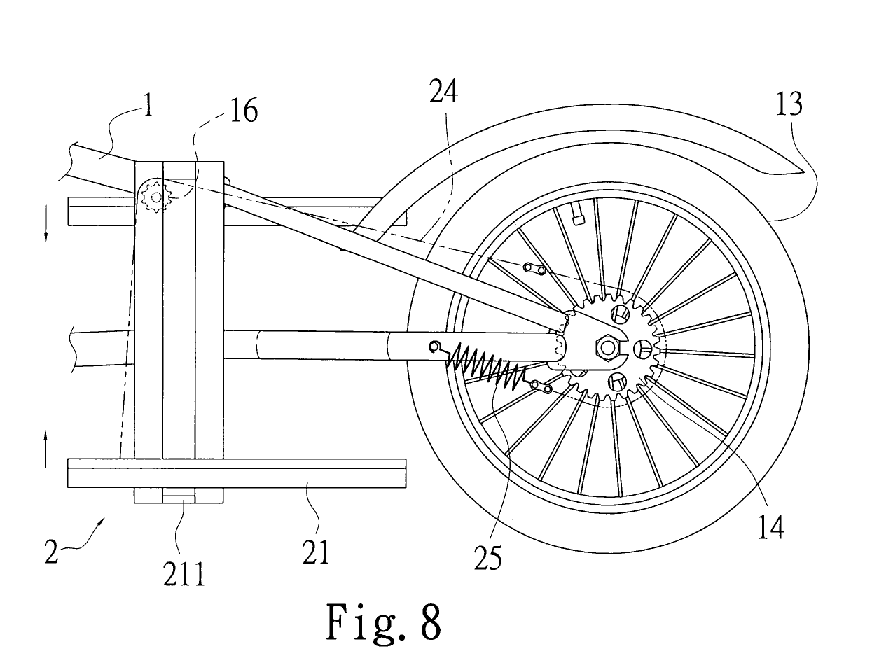

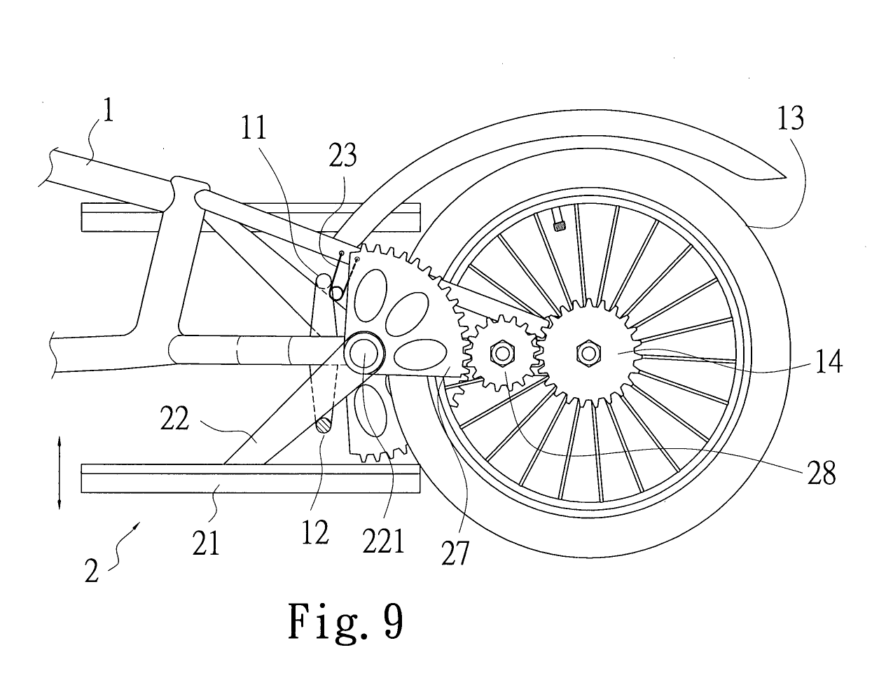

Moreover, referring to the schematic view of the third embodiment as shown in FIG. 6, the transmission member (26) of the transmission unit (2) can be a belt. Furthermore, referring to the schematic view of the fourth embodiment as shown in FIG. 7, the difference between this embodiment and the second embodiment is described as below. The cranks (22) of the transmission units (2) are pivotally connected to the side edges near the bottom centers of the bicycle body (1) respectively, and the upper limiters (11) and the lower limiters (12) of the bicycle body (1) are provided, corresponding to the upper and lower ends of the cranks (22), at the middle segment places of the bottom end of the bicycle body (1) so as to limit the working range of the cranks (22). Further, referring to the schematic view of the fifth embodiment as shown in FIG. 8, the pedal (21) of each transmission unit (2) is provided with a vertical rail (211) for facilitating the up-and-down movement of the pedal (21) and the transmission member (24) is fixedly connected to the pedal (21) so as to drive the bicycle body (1) moving forward. Furthermore, referring to the schematic view of the sixth embodiment as shown in FIG. 9, an active gear (27) fixed to the other end of the crank (22) of each transmission unit (2) meshes with a passive gear (28) which in turn meshes with the freewheel (14) of the bicycle body (1). When one pedal is stamped down, the active gear (27) conducts counterclockwise rotation until the crank (22) abuts against the lower limiter (12), simultaneously the passive gear (28) is moved by the active gear (27) to conduct clockwise rotation. In turn, the freewheel (14) and the rear wheel (13) are rotated in counterclockwise direction by the passive gear (28) so as to drive the bicycle body (1) moving forward. When the force applied on the pedal (21) is stopped, the elastic member (23) pull the crank (22) upward so that the pedal (21) is restored to its original position until the crank (22) abuts against the upper limiter (11). In this manner, the process of stamping on each pedal (21) is repeatedly conducted to allow the bicycle body (1) to keep on moving.

The above-mentioned embodiments and drawings are not used to limit the product aspects, transmission structure or usage mode of the present invention. Equivalent variations and modifications made by the person skilled in the art without departing from the spirit and scope of the present invention are still considered to be within the scope of the present invention.

Based on the description of the elements constitution and the implementation of foregoing, the bicycle structure of the present invention has the following advantages when comparing with the conventional structure.
1. The bicycle of the present invention is adapted for stand-riding which has short wheel base between the front and the rear wheels, light-weight, small volume, cost-saving effect, and which can achieve utmost downsizing after folding for easy carry and for easy storage in the trunk of car.
2. Each transmission unit of the present invention is independently operated. When the whole weight of the rider is applied on his two feet, the cranks of both sides move downward until the cranks abut against the lower limiters. At this moment, the two pedals are present at the same height level so that the rider can stand on the pedals comfortably and enjoy the free-moving of the bicycle body (1).
3. In the bicycle of this invention, the bicycle body can be driven to move forward merely by providing pedals moving up-and-down on both sides respectively on the bottom and by connecting each pedal to respective transmission unit. Therefore, its structure is simple and is easy for assembly.
4. A number of speed change points can be provided on transmission units of the present invention so as to achieve the goal of increasing the stroke of freewheels. Therefore, it possesses convenience in practical implementation thereof.

Summing up above, the above embodiments of this invention can reach expected effectiveness, and the specific structure disclosed herein have yet not seen in the prior art of the same category of product, even has not been opened to the public before application.

What is claimed is:

1. A bicycle, comprising:
a bicycle body being pivoted with a rear wheel on the rear side thereof and the rear wheel being provided with plural freewheels;
a plurality of independent transmission units each being provided respectively at both sides of the bottom of the bicycle body, including pedals moving up and down and being connected to the freewheels.

2. A bicycle as claimed in claim 1, wherein said pedals are connected with cranks, the side edges of which are pivotally connected to the sides of said bicycle body and the other ends of which being pivotally connected in bias to said freewheels.

3. A bicycle as claimed in claim 2, wherein upper limiters and lower limiters are fixed respectively at both sides of the bicycle body, on the upper and lower ends corresponding to said cranks.

4. A bicycle as claimed in claim 1, wherein said cranks drive transmission members and said transmission members are engaged on the outer peripheral edges of said freewheels.

5. A bicycle as claimed in claim 4, wherein each said transmission members is a chain.

6. A bicycle as claimed in claim 4, wherein each said transmission member is a belt.

7. A bicycle as claimed in claim 4, wherein said speed change points are provided on said cranks and said transmission members are fixedly connected to the speed change points on said cranks.

8. A bicycle as claimed in claim 4, wherein upper limiters and lower limiters are fixed respectively at both sides of the bicycle body, on the upper and lower ends corresponding to said cranks.

9. A bicycle as claimed in claim 1, wherein the other ends of said cranks are fixedly connected with active gears which drive said freewheels.

10. A bicycle as claimed in claim 9, wherein said active gears mesh with passive gears mesh which in turn mesh with the peripheral edges of said freewheels.

11. A bicycle as claimed in claim 1, wherein said pedals are provided with vertical rails respectively.
